(19) United States
(12) Patent Application Publication
(10) Pub. No.: US 2006/0137753 A1
(43) Pub. Date: Jun. 29, 2006

(54) Plumbing tool for temporarily plugging a pipe

(76) Inventor: Stephen S. Peterson, Chanhassen, MN (US)

Correspondence Address: MICHAEL H JESTER, 505 D GRAND CARIBE CAUSEWAY, CORONADO, CA, 92118, US

(21) Appl. No.: 11/023,938

(22) Filed: Dec. 27, 2004

(51) Int. Cl. F16L 55/10

(52) U.S. Cl. 138/89

(57) ABSTRACT

A hollow elongate tube surrounds an elongate rod intermediate its proximal and distal segments. A resilient deformable seal surrounds the distal segment. The seal is secured to prevent movement of the seal in a forward direction off the distal segment of the rod. A cam mechanism is connected to the proximal segment of the rod and is movable to pull the rod in a rearward direction through the tube to squeeze the seal in an axial direction. This causes the seal to expand in a radial outward direction against an inner wall of a pipe into which the seal has been inserted. A lever is connected to the cam mechanism to facilitate manual movement of the cam mechanism to expand the seal.

### FIELD OF THE INVENTION

The present invention relates to plumbing tools, and more particularly, to plumbing tools that can be used to temporarily seal a water pipe to allow removal and replacement of valves without having to completely drain the entire water system.

### BACKGROUND OF THE INVENTION

Plumbers frequently need to replace gate valves on water pipes in homes and buildings. Often the replacement valve must be soldered in place. It is time consuming to drain the water pipe so that the old valve can be removed and the new valve installed. Numerous plumbing tools have been invented to temporarily seal a water pipe upstream of the gate valve to permit its replacement without having to drain the main water supply. They usually have a rod with a rubber seal that is inserted through the gate valve and then expanded to prevent the flow of water to the gate valve.

One example of a plumbing tool for temporarily sealing a water pipe is disclosed in U.S. Pat. No. 5,363,881 of Larkin. A hollow sleeve is co-axially disposed around an elongate threaded rod. A cylindrical gasket is disposed around a distal segment of the rod between the distal end of the hollow sleeve and a washer secured to the distal end of the rod with a cap nut. A tubular nut is screwed over a proximal threaded segment of the threaded rod and engages a proximal end of the hollow sleeve. The tubular nut can be held with a wrench and a handle connected to the proximal end of the threaded rod can be rotated to axially squeeze the gasket and cause it to radially expand against a pipe wall. The washer is keyed to the threaded distal segment of the rod to prevent relative rotation of the washer that would unscrew the cap nut off the rod.

U.S. Pat. No. 6,508,267 of Rippolone discloses another plumbing tool for temporarily sealing a water pipe in which a resilient sealing member partially inverts when a hollow shaft member is partially retracted from a pipe. Water is then diverted through the hollow shaft member which is connected to a drain hose.

Prior devices for temporarily sealing a water pipe have not been convenient to install and bring to a positive sealing state.

### SUMMARY OF THE INVENTION

In accordance with the present invention a plumbing tool includes an elongated rod having a proximal segment and a distal segment. A hollow elongate tube surrounds the rod intermediate the proximal segment of the rod and the distal segment of the rod. A resilient deformable seal surrounds the distal segment. The seal is secured to prevent movement of the seal in a forward direction off the distal segment of the rod. A cam mechanism is connected to the proximal segment of the rod and is movable to pull the rod in a rearward direction through the tube to squeeze the seal in an axial direction. This causes the seal to expand in a radial outward direction against an inner wall of a pipe into which the seal has been inserted. A lever is connected to the cam mechanism to facilitate manual movement of the cam mechanism to expand the seal.

### BRIEF DESCRIPTION OF THE DRAWINGS

FIG. 1 is a side elevation view of an embodiment of a plumbing tool embodying my invention.

FIG. 2 is a stylized side elevation view of a water pipe with portions cut away showing the manner in which the plumbing tool of FIG. 1 may be installed therein to facilitate removal and replacement of a gate valve connected to the end of the pipe.

### DESCRIPTION OF THE PREFERRED EMBODIMENT

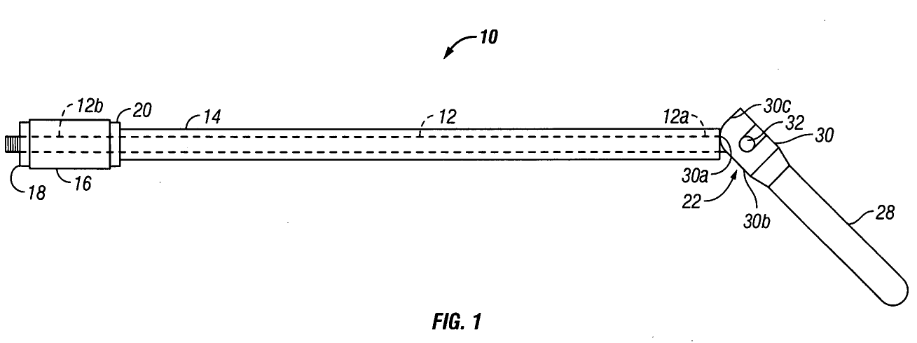

Referring to FIG. 1, a plumbing tool 10 includes an elongated steel rod 12 having a proximal segment 12a and a distal segment 12b. An elongate hollow steel tube 14 surrounds the rod 12 intermediate the proximal segment 12a of the rod and the distal segment 12b of the rod. A resilient deformable cylindrical rubber seal 16 with a bore through the center thereof surrounds the distal segment 12b of the rod. The seal 16 is secured to prevent movement of the seal 16 in a forward direction (to the left in FIG. 1) off the distal segment 12b of the rod 12. A retaining member in the form of a threaded washer 18 is screwed over the threaded distal segment 12b of the rod 12 and abuts the forward end of the seal. A second washer 20 that is not threaded surrounds the distal segment 12b of the rod 12 and is positioned between the seal 16 and the distal end of the tube 14. The washers 18 and 20 can be bonded to the rubber seal 16 or they can also be loose relative to the rubber seal 16. Bonding the washers 18 and 20 to the rubber seal 16 is preferred because it makes it easy to replace this part of the tool 10.

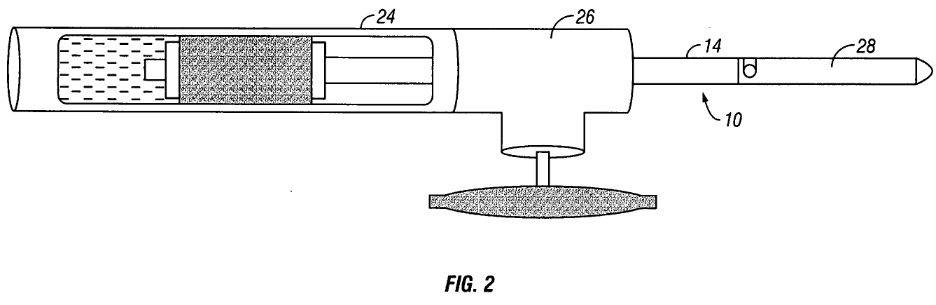

A cam mechanism 22 (FIG. 1) is connected to the proximal segment 12a of the rod and is movable to engage a proximal end of the tube 14 to pull the rod 12 in a rearward direction (to the right in FIG. 1) through the tube 14. This squeezes the seal 16 in an axial direction between the washers 18 and 20. This is because the washer 18 is prevented from sliding axially along the rod 12 due to the threaded connection between the washer 18 and the rod 14. The washer 20 engages and is stopped by the distal end of the tube 14. The axial squeezing of the seal 16 causes the seal 16 to expand in a radial outward direction against an inner wall of a water pipe 24 (FIG. 2) into which the plumbing tool 10, including the seal 16 thereof, has been inserted. This permits a gate valve 26 to be removed from the end of the pipe 24 and replaced, via soldering, without having to drain of water from the pipe 24.

A lever 28 (FIG. 1) is connected to the cam mechanism 22 to facilitate manual movement of the cam mechanism 22 to expand the seal 16. The cam mechanism comprises a cam body 30 (FIG. 1) preferably made of machined steel and a pivotal connection between the cam body 30 and the proximal segment 12a of the rod 12. The pivotal connection includes a pivot pin 32 welded or otherwise secured to the end of the proximal segment 12a of the rod 12 at a ninety degree angle relative to the axis of the rod 12. The cam body 30 has a curved shoulder 30a that engages the proximal end of the tube 14.

The cam body 30 also has a first straight surface 30b adjoining a first end of the curved shoulder 30a and a second straight surface 30c adjoining a second end of the curved shoulder 30a. The straight surfaces 30b and 30c are differentially positioned relative to a pivot point or center of the pivot pin 32 so that when the first straight surface 30b of the cam body 30 engages the proximal end of the tube 14 the seal 16 is not deformed. When the second straight surface 30c of the cam body 30 engages the proximal end of the tube 14 the seal 16 is radially expanded.

By lifting or rotating lever 28 the rubber seal 16 can be seated inside the pipe 24 to form a water tight seal. The straight surfaces 30b and 30c of the cam body 30 enable a transition between unsealed and sealed configurations of the plumbing tool 10. The curved shoulder 30a has the effect of providing an over-center feature so that the plumbing tool 10 will positively remain in its sealed configuration when the plumber installs it in the pipe as illustrated in FIG. 2, twists the lever ninety degrees away from its unsealed configuration and releases the lever 28. The central longitudinal axis of the lever 28 is co-linear with the central longitudinal axes of the tube 14 and rod 12 when the plumbing tool 10 is in its sealed configuration. This allows the old gate valve 26 to be slid over the tool 10 and replaced with a new gate valve. The degree of radial expansion of the seal 16, and thus the integrity of the water tight seal, can be improved by screwing the threaded washer 18 further backward (to the right in FIG. 1). The lever 28 and cam body 30 provide a mechanical advantage that allow the plumber to easily deform the seal 16 into sealing engagement with the inside wall of the pipe 24. However, excessive rearward screwing (to the right in FIG. 1) of the washer 18 will make it too difficult to move the lever 28 all the way to its ninety degree position.

While I have described a preferred embodiment of my plumbing tool, modifications and adaptations thereof will occur to those skilled in the art. For example, different diameter seals may be used in place of the seal 16 to accommodate different pipe diameters. This is a very important feature to plumbers in terms of convenience. A washer or other member (not illustrated) can be positioned around the rod 12 between the cam body 30 and the proximal end of the tube 14 to reduce wear on the tube 14. Therefore, the protection afforded my invention should only be limited in accordance with the following claims.

I claim:

1. A plumbing tool, comprising:
an elongated rod having a proximal segment and a distal segment;
a hollow elongate tube surrounding the rod intermediate the proximal segment of the rod and the distal segment of the rod;
a resilient deformable seal surrounding the distal segment;
means for securing the seal to prevent movement of the seal in a forward direction off the distal segment of the rod;
cam means connected to the proximal segment of the rod and movable to engage a proximal end of the tube to pull the rod in a rearward direction through the tube to squeeze the seal in an axial direction to cause the seal to expand in a radial outward direction against an inner wall of a pipe into which the seal has been inserted; and
lever means connected to the cam means to facilitate manual movement of the cam means to expand the seal.

2. The plumbing tool of claim 1 wherein the distal segment of the rod is threaded and the securing means comprises a retaining member screwed over the threaded distal segment of the rod and abutting a forward end of the seal.

3. The plumbing tool of claim 2 wherein the retaining member is a washer.

4. The plumbing tool of claim 3 and further comprising a second washer surrounding the distal segment of the rod and positioned between the seal and a distal end of the tube.

5. The plumbing tool of claim 1 wherein the cam means comprises a cam body and a pivotal connection between the cam body and the proximal segment of the rod.

6. The plumbing tool of claim 5 wherein the cam body has a curved shoulder that engages the proximal end of the tube.

7. The plumbing tool of claim 6 wherein the cam body has a first straight surface adjoining a first end of the curved shoulder and a second straight surface adjoining a second end of the curved shoulder, the straight surfaces being differentially positioned relative to a pivot point of the pivotal connection so that when the first straight surface of the cam body engages the proximal end of the tube the seal in not deformed and when the second straight surface of the cam body engages the proximal end of the tube the seal is radially expanded.

8. The plumbing tool of claim 1 wherein the seal has a cylindrical shape.

9. The plumbing tool of claim 1 wherein the seal is made of rubber.

10. The plumbing tool of claim 5 wherein the pivotal connection includes a pivot pin.

11. A plumbing tool, comprising:
an elongated rod having a proximal segment and a distal segment;
a hollow elongate tube surrounding the rod intermediate the proximal segment of the rod and the distal segment of the rod;
a resilient deformable seal surrounding the distal segment;
means for securing the seal to prevent movement of the seal in a forward direction off the distal segment of the rod;
a member surrounding the rod and positioned adjacent a proximal end of the tube;
cam means connected to the proximal segment of the rod and movable to engage the member to pull the rod in a rearward direction through the tube to squeeze the seal in an axial direction to cause the seal to expand in a radial outward direction against an inner wall of a pipe into which the seal has been inserted; and
lever means connected to the cam means to facilitate manual movement of the cam means to expand the seal.

12. The plumbing tool of claim 11 wherein the distal segment of the rod is threaded and the securing means comprises a retaining member screwed over the threaded distal segment of the rod and abutting a forward end of the seal.

13. The plumbing tool of claim 12 wherein the retaining member is a washer.

14. The plumbing tool of claim 13 and further comprising a second washer surrounding the distal segment of the rod and positioned between the seal and a distal end of the tube.

15. The plumbing tool of claim 11 wherein the cam means comprises a cam body and a pivotal connection between the cam body and the proximal segment of the rod.

16. The plumbing tool of claim 15 wherein the cam body has a curved shoulder that engages the proximal end of the tube.

17. The plumbing tool of claim 16 wherein the cam body has a first straight surface adjoining a first end of the curved shoulder and a second straight surface adjoining a second end of the curved shoulder, the straight surfaces being differentially positioned relative to a pivot point of the pivotal connection so that when the first straight surface of the cam body engages the proximal end of the tube the seal in not deformed and when the second straight surface of the cam body engages the proximal end of the tube the seal is radially expanded.

18. The plumbing tool of claim 11 wherein the seal has a cylindrical shape.

19. The plumbing tool of claim 15 wherein the pivotal connection includes a pivot pin.

20. A plumbing tool, comprising:
an elongated rod having a proximal segment and a male threaded distal segment;
a hollow elongate tube surrounding the rod intermediate the proximal segment of the rod and the distal segment of the rod;
a resilient deformable cylindrical seal surrounding the distal segment;
a first washer screwed over the male threaded distal segment of the rod and abutting a forward end of the seal means to prevent movement of the seal in a forward direction off the distal segment of the rod;
a second washer surrounding the distal segment of the rod and positioned between the seal and a distal end of the tube;
cam means connected to the proximal segment of the rod and movable to engage a proximal end of the tube to pull the rod in a rearward direction through the tube to squeeze the seal in an axial direction between the first and second washers to cause the seal to expand in a radial outward direction against an inner wall of a pipe into which the seal has been inserted, the cam means including a cam body and a pivotal connection between the cam body and the proximal segment of the rod, the cam body having a curved shoulder that engages the proximal end of the tube, and the cam body having a first straight surface adjoining a first end of the curved shoulder and a second straight surface adjoining a second end of the curved shoulder, the straight surfaces being differentially positioned relative to a pivot point of the pivotal connection so that when the first straight surface of the cam body engages the proximal end of the tube the seal in not deformed and when the second straight surface of the cam body engages the proximal end of the tube the seal is radially expanded; and
lever means connected to the cam body to facilitate manual movement of the cam means to expand the seal.
